(19) United States
(12) Patent Application Publication
(10) Pub. No.: US 2013/0167323 A1
(43) Pub. Date: Jul. 4, 2013

(54) FURNITURE HINGE

(71) Applicant: JULIUS BLUM GMBH, Hochst (AT)

(72) Inventor: Harald BRUNNMAYR, Horbranz (AT)

(73) Assignee: JULIUS BLUM GMBH, Hochst (AT)

(21) Appl. No.: 13/777,461

(22) Filed: Feb. 26, 2013

Related U.S. Application Data
(63) Continuation of application No. PCT/AT2011/000354, filed on Aug. 26, 2011.

(30) Foreign Application Priority Data
Aug. 27, 2010 (AT) A 1435/2010

(51) Int. Cl. E05F 3/20

(52) U.S. Cl. CPC E05F 3/20
USPC 16/50

(57) ABSTRACT

The invention relates to a furniture hinge (100), comprising at least one control cam (3, 13) and at least one spring (2, 12), wherein the control cam (3, 13) moves along on the spring (2, 12) in order to produce a closing force and/or opening force, wherein a sliding element (1, 11, 21, 31) is attached to the spring (2, 12) and/or to the control cam (3, 13). The control cam (3, 13) or the spring (2, 12) moves along on the sliding element.

The invention relates to a furniture hinge with at least one control cam and at least one spring, wherein the control cam moves along on the spring in order to produce a closing force and/or opening force.

The invention further relates to a piece of furniture with at least one movable furniture part, wherein the furniture part is movably mounted via at least one furniture hinge.

A large number of such furniture hinges are already known from the state of the art. A disadvantage of such furniture hinges is that, because of the high spring load for producing the closing and/or opening force, the spring will break after a certain number of movements of the furniture hinge.

The object of the invention is to avoid the above-described disadvantage and to provide a furniture hinge that improves on the state of the art.

This object is achieved by a furniture hinge with the features of claim 1.

The use of a sliding element increases the life of the spring, which contributes to a furniture hinge that functions for longer.

Further advantageous embodiments of the invention are defined in the dependent claims.

It has proved particularly advantageous if the furniture hinge has a fitting for attachment to a first furniture part and a hinge cup for attachment to a second furniture part, wherein the hinge cup is swivellably connected to the fitting via at least one articulated lever, wherein the control cam is formed on the articulated lever. The control cam can be formed on the articulated lever with little technical outlay, whereby the costs can be kept low.

According to a preferred embodiment example, it can be provided that the sliding element is pushed onto the spring and/or is attached to the control cam. The pushing of the sliding element onto the spring can be carried out technically very simply, likewise the attachment to the control cam.

Furthermore, it can preferably be provided that the sliding element is at least partially—preferably substantially completely—formed from plastic and/or that the spring is formed from metal—preferably from steel. The sliding element can be formed from plastic technically well and the shaping can preferably be carried out for instance using an injection-molding method, the construction of the spring or springs out of metal can guarantee a long-lasting consistent spring property, wherein it has been shown that especially the formation from steel can be particularly suitable.

It has proved particularly advantageous if the plastic of the sliding element is formed as a thermoplastic—preferably polyoxymethylene (POM). Thermoplastics can have good rigidity values and good coefficients of friction, in particular the thermoplastic material polyoxymethylene (POM, also called polyacetal or polyformaldehyde)—because of its high rigidity, its low coefficients of friction and its excellent dimensional stability and also thermal stability—can preferably be used particularly for a precision part such as that of the sliding element.

It can particularly preferably be provided that the sliding element is attached to one end of the spring. The attachment of the sliding element to the spring, especially at its end, can take place simply—such as for instance by being pushed on.

It has proved particularly advantageous if the sliding element has at least one reservoir for a lubricant. By forming a reservoir in the sliding element, the control cam and/or the spring can be supplied with a lubricant that can be introduced into the reservoir.

According to a preferred embodiment example, it can be provided that the sliding element has an outer contour differing from the cylinder shape. An outer contour of the sliding element differing from the cylinder shape makes it possible to achieve a larger contact surface for the control cam, whereby point abrasion can be minimized.

It has further proved advantageous that the sliding element has a substantially cylindrical cavity. Through the formation of a substantially cylindrical cavity in the sliding element, the latter can be attached to the spring in a simple way—slid on in this preferred case.

It has proved advantageous if the sliding element has at least one control cam or at least one projection. Due to the formation of a control cam or a projection on the sliding element, the sliding element can also influence the control curve.

It has proved particularly advantageous if the sliding element has a curved plane, wherein the curved plane is formed substantially straight in a transverse extension and is formed curved in a longitudinal extension. It can thus be achieved that the bearing surface of the sliding element against the spring or against the control cam is enlarged, whereby point loads can be avoided.

According to a preferred embodiment example, it can be provided that the sliding element has a channel-shaped groove. Due to the formation of a channel-shaped groove in the sliding element, a spring having a circular cross-section can slide in the channel-shaped groove, whereby an enlargement of the bearing surface can likewise result.

Furthermore, it can preferably be provided that the sliding element is formed as a separate assembly.

Preferably, it can furthermore be provided that the sliding element is formed in one piece. Especially a one-piece formation of the sliding element can contribute to a simple production process for the sliding element.

According to a possible embodiment example, it can be provided that the furniture hinge has at least two sliding elements. Due to the formation of two sliding elements in the furniture hinge, a symmetrical formation on the furniture hinge can take place, which can contribute to a uniform loading of the furniture hinge during the closing and opening movements.

According to a preferred embodiment example, it can be provided that the spring has a substantially cylindrical cross-section at least at one end. This can likewise contribute to the fact that the sliding element can be slid simply onto the end of the spring, whereby a simple assembly can be achieved.

It has proved particularly advantageous if the spring has a circular cross-section at least in some areas.

Advantageously, the spring is formed as a leg spring, whereby a constant bending moment can be achieved.

Specifically, protection is also sought for a piece of furniture with at least one movable furniture part, wherein the furniture part is movably mounted via at least one furniture hinge according to at least one of the described embodiments.

Further details and advantages of the present invention are explained in more detail below with the help of the description of the figures with reference to the embodiment examples represented in the drawings.

There are shown in:

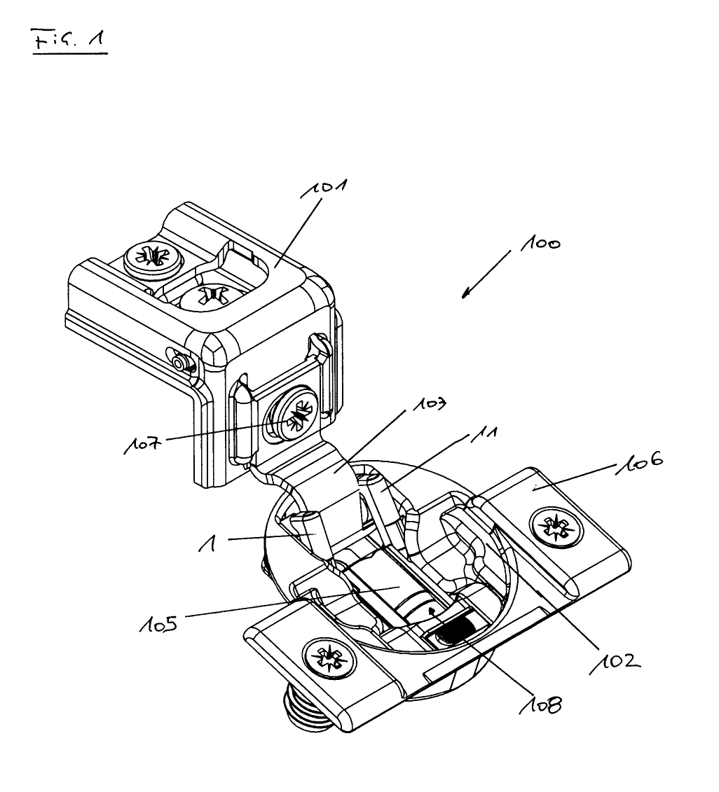

FIG. 1 a perspective representation of a furniture hinge,

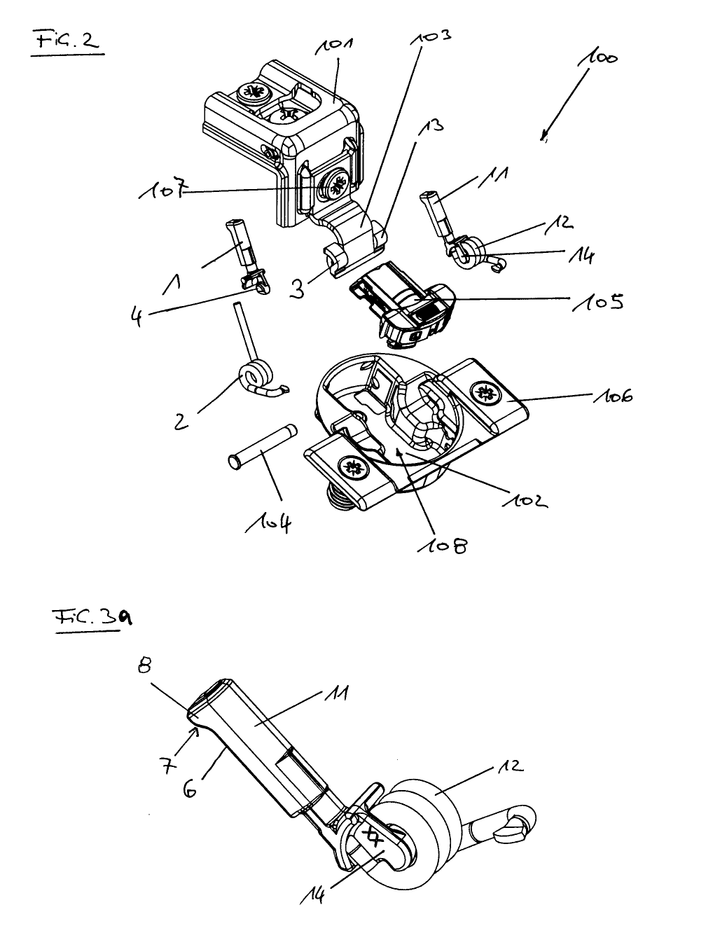

FIG. 2 a perspective exploded representation of the furniture hinge in FIG. 1,

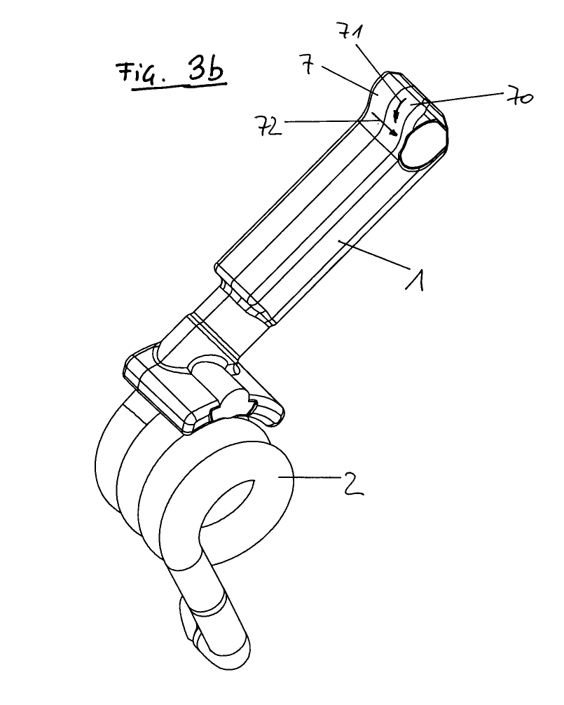

FIGS. 3a and 3b two perspective representations of a spring and a sliding element arranged thereon,

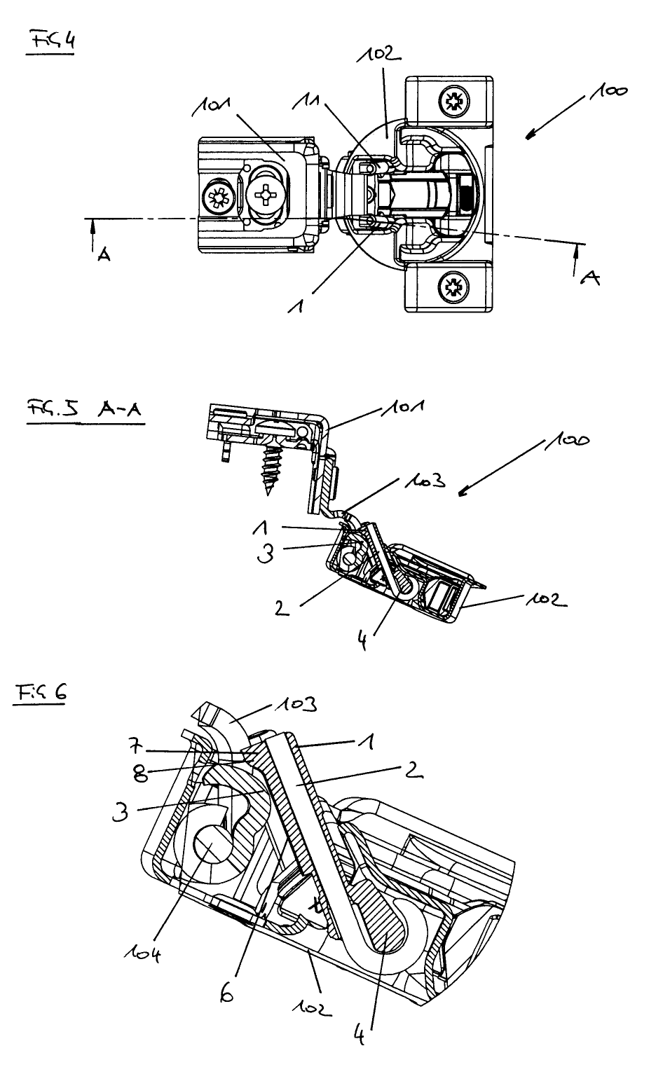

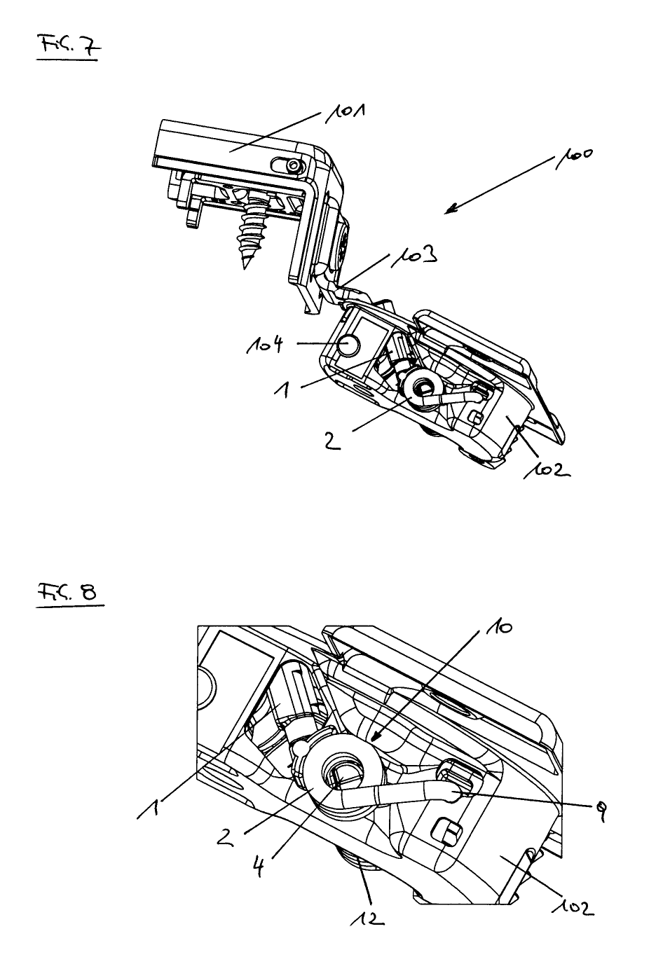

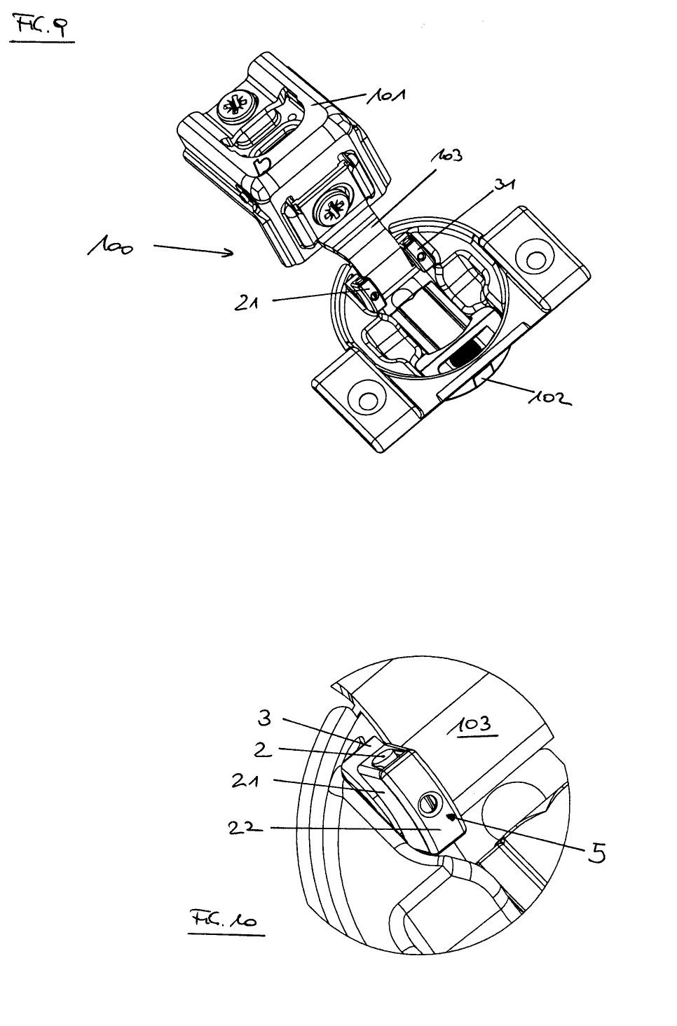

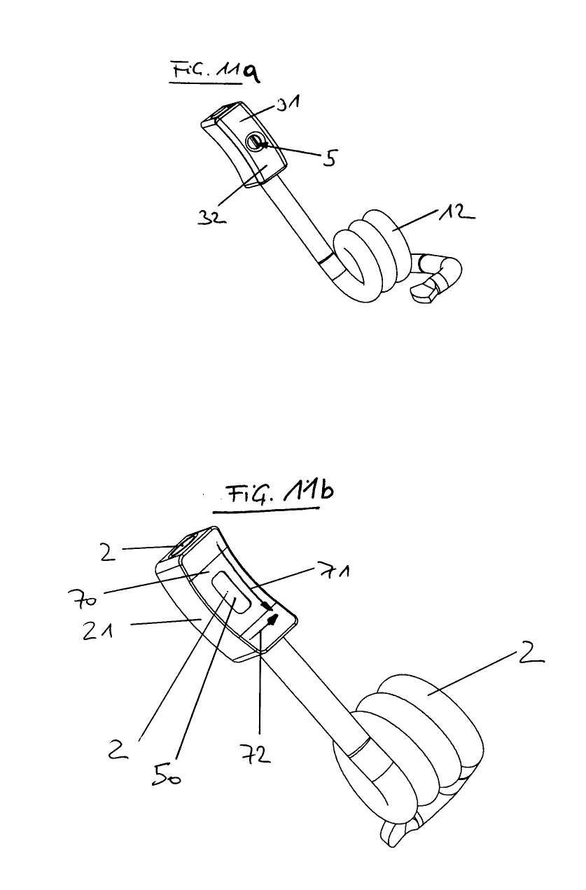

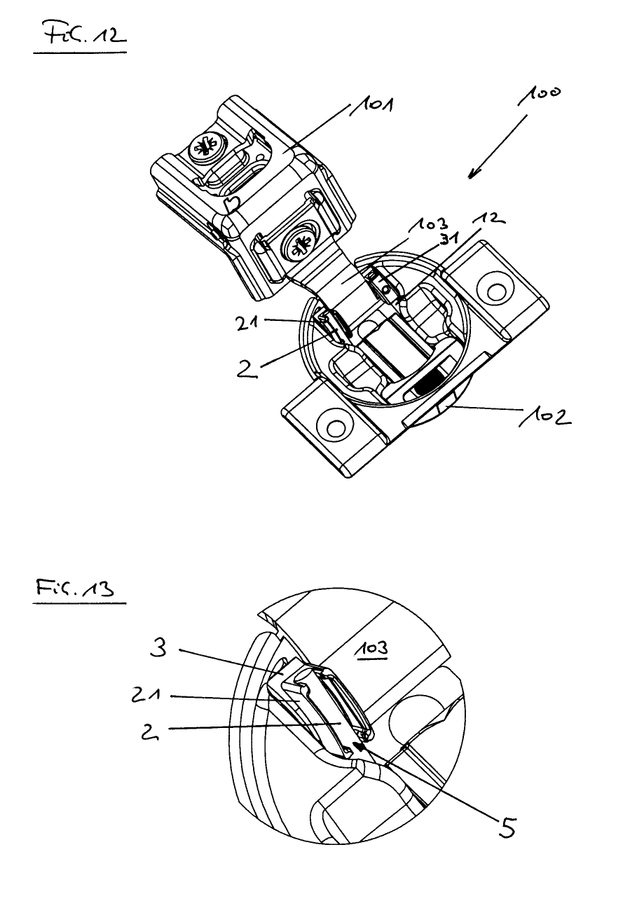

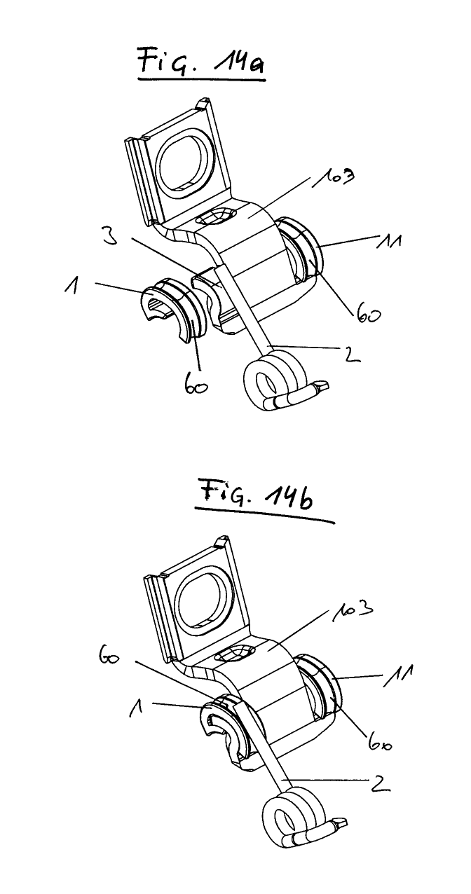

FIG. 4 the top view of a furniture hinge,

FIG. 5 the section through the side view of a furniture hinge as represented in FIG. 4,

FIG. 6 a detail view through the section of the furniture hinge represented in FIG. 5,

FIG. 7 a perspective view of a furniture hinge,

FIG. 8 a detail view of the furniture hinge represented in FIG. 7,

FIG. 9 a further embodiment example of a furniture hinge with a sliding element with reservoir in perspective view,

FIG. 10 a detail view from FIG. 9,

FIGS. 11a and 11b two perspective views of a spring and a sliding element arranged thereon with reservoir,

FIG. 12 a perspective view of a furniture hinge, in which a cover has been removed from a sliding element,

FIG. 13 a detail view of the sliding element without cover as represented in FIG. 12,

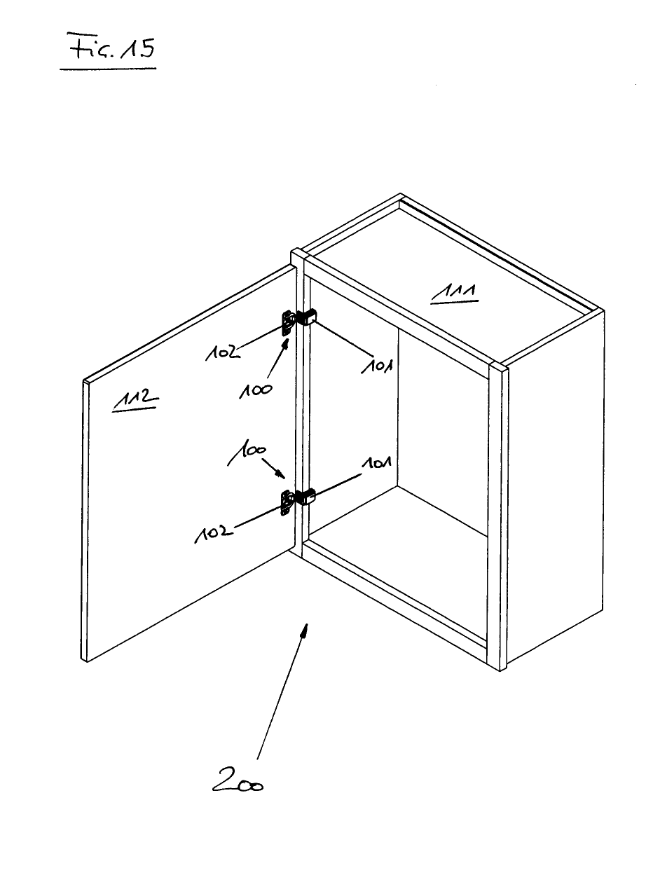

FIGS. 14a and 14b an exploded representation of an articulated lever of a furniture hinge with sliding element and leg spring and of the articulated lever in perspective representation in the assembled state,

FIG. 15 a piece of furniture with two furniture hinges and a movable furniture part.

FIG. 1 shows the perspective representation of a furniture hinge 100. This furniture hinge 100 has a fitting 101 for attachment to a first furniture part (not shown) and a hinge cup 102 for attachment to a second furniture part (not shown). The hinge cup 102 is attached to the second furniture part via its attachment flange 106. In this embodiment example, an adjustment device 107 is formed on the fitting 101. The fitting 101 is swivellably connected to the hinge cup 102 via an articulated lever 103. An optional damping device 105 with depressible slider which can damp the closing process of the furniture hinge 100 and thus of the movable furniture part is arranged in the inner cavity 108 of the hinge cup 102.

In this preferred embodiment example, two sliding elements 1 and 11 are arranged above the springs 2 and 12, not visible in this representation. The control cams 3 and 13, not visible here in this figure (see FIG. 2 in this connection), move along on these sliding elements 1 and 11.

FIG. 2 shows a perspective exploded representation of the furniture hinge 100 as represented in FIG. 1. In this embodiment example, the furniture hinge 100 is designed as a single-point hinge, naturally a sliding element is likewise also conceivable and desired for other hinges—such as for instance four-point hinges.

In this especially preferred embodiment example, the furniture hinge 100 has the two control cams 3 and 13 on the articulated lever 103, which can be connected on the one hand to hinge cup 102 via the pin 104 and on the other hand to the fitting 101 via the adjustment device 107. In this embodiment example, the sliding element 1, preferably formed in one piece, is put on the spring 2, over the spring end. This sliding element 1 preferably has better sliding properties than metal. The attachment device 4, which is preferably formed in the form of a snap connection, can engage in the coils of the spring 2, which is preferably formed as a leg spring, after being put on (see FIGS. 3a and 3b in this connection), whereby it can be ensured that the sliding element 1 can maintain its position relative to the spring 2. In the assembled state, during the opening and closing process, the sliding element 1 moves along over the control cam 3 of the articulated lever 103.

In this preferred embodiment example, the articulated lever 103 has the further control cam 13, a sliding element 11 is likewise arranged on the control cam 13. This sliding element 11 is—as just described for the sliding element 1—connected to a further spring 12 via its attachment device 14.

The attachment of the two springs 2 and 12 in the furniture hinge 100 takes place in this preferred embodiment example on the outside of the hinge cup 102 (see the description of the figures for FIGS. 7 and 8 in this connection).

FIG. 3a is a detail representation of a spring 12 and a sliding element 11 attached to this spring 12 in perspective view. The sliding element 11 is connected, stationary, to the spring 12 via the attachment device 14. As can be clearly seen from this detail representation, the sliding element 11 has an outer contour 6 differing from the cylinder shape, in this case inter alia a projection 8, on which a control cam 7 is formed.

The outer contour 6 furthermore preferably has a level surface (not shown) which corresponds to the control cam 13 of the articulated lever 103.

In this preferred embodiment example, the sliding element 11 is formed from a plastic—a thermoplastic such as polyoxymethylene (POM) is particularly preferred. The spring 12 is formed in this preferred embodiment example from a metal—steel is particularly preferred.

FIG. 3b shows, in perspective representation, a spring 2 to which a sliding element 1 is attached. The sliding element 1 has been pushed over the leg spring 2 provided with a circular cross-section and with coils.

The sliding element 1 has a control cam 7. This control cam 7 in turn has a curved plane 70, wherein this curved plane 70 is formed substantially straight in its transverse extension 72 and is formed curved in its longitudinal extension 71. It can thereby be achieved that the bearing surface of the sliding element 1 is not only supported at a point against a control cam, not shown here, of an articulated lever (likewise not shown), but a support at least along a line results. Point loads can thus be avoided.

FIG. 4 shows a top view of a furniture hinge 100 which has two sliding elements 1 and 11, which move along on the control cams 3 and 13 (not shown), wherein the two sliding elements 1 and 11 are arranged on the springs 2 and 12 (not shown) in order to produce a closing force and/or opening force.

FIG. 5 shows a side representation of the furniture hinge 100 in the section of the furniture hinge of FIG. 4. The fitting 101 is connected to the hinge cup 102 via the articulated lever 103.

During the swiveling of the fitting 101 relative to the hinge cup 102, in this embodiment example, the sliding element 1, together with the spring 2, moves along on the control cam 3.

In a detail view—represented in FIG. 6—it can be clearly seen that this sliding element 1 has an outer contour 6 differing from the cylinder shape, which is revealed by a further control cam 7 and the projection 8. The sliding element 1 is attached to the spring 2 and this sliding element 1 moves along on the control cam 3 in order to produce a closing force and/or opening force. Likewise, it would naturally also be conceivable that the control cam 3 is not formed on the articulated lever 103, as in this preferred embodiment example, but that the sliding element 1 has the control cam 7 only in order to produce a closing and/or opening force, wherein this control cam 7 would then naturally have another contour. In this embodiment example, the sliding element 1 has a substantially cylindrical cavity, in which the spring 2, which has a substantially cylindrical cross-section at least at one end, is arranged.

FIG. 7 shows a further perspective representation of a furniture hinge 100, as just described. It can be clearly seen especially in the detail view of FIG. 8 that the spring 2 is preferably formed as a leg spring. One end 9 of the spring 2 is attached to the hinge cup 102 and the coils of the leg spring 2 are supported on the support point 10 of the hinge cup 102. The support point 10 is formed as a contact surface for the coils of the spring 2. The above-mentioned likewise relates analogously to the spring 12 on the other side of the hinge cup 102.

FIG. 9 shows the perspective representation of a further embodiment example of a furniture hinge 100 with sliding elements 21 and 31.

As shown in the detail representation of FIG. 10, the sliding element 21 has a cover 22 which can be formed detachable. Below the cover 22 there is a reservoir 5 in the sliding element 21 which serves to hold a lubricant, not shown. In this embodiment example, the sliding element 21 is now connected, stationary, to the control cam 3. Over the whole life of the furniture hinge 100 the sliding element 21 dispenses the lubricant from its reservoir 5 at the bearing point between spring 2 and the control cam 3.

FIG. 11a shows a detail representation of the leg spring 12 and the sliding element 31 arranged thereon, which has a cover 32 below which there is a reservoir 5 for holding a lubricant.

FIG. 11b shows a detail representation in perspective view of the spring 2 and a sliding element 21 arranged thereon. In this perspective bottom view of the sliding element 21 it can be clearly seen that the sliding element 21 has an opening 50 through which a lubricant can exit and thus likewise can contribute to a positive sliding behavior.

Likewise, this underside of the sliding element 21 is not formed flat, but the sliding element 21 has a curved plane 70, wherein the curved plane 70 is formed substantially straight in its transverse extension 72 and is formed curved in its longitudinal extension 71. In this representation, it can again be clearly seen that the spring 2 is formed as a leg spring and has a circular cross-section, whereby it is made easier to arrange the spring 2 on the sliding element 21.

FIG. 12 shows a further perspective representation of a furniture hinge 100 as just described in FIGS. 9, 10 and 11, wherein in this representation the sliding element 31 has a closed cover 32 and the sliding element 21 is represented without the cover 22.

During the swiveling of the fitting 101 relative to the hinge cup 102, in this embodiment example, the spring 2 in the sliding element 1 moves along on the control cam 3.

The detail view of FIG. 13 shows the reservoir 5 which is located in the interior of the sliding element 21. This reservoir 5 can be filled with a lubricant (not shown) and then lubricates the bearing point between spring 2 and the control cam 3 of the articulated lever 103 of the furniture hinge 100.

FIG. 14a shows the articulated lever 103 of a furniture hinge in perspective representation. The articulated lever 103 has inter alia the control cam 3. The sliding element 1 formed in one piece in this preferred embodiment example can be pushed over this control cam 3 and thus be attached to the articulated lever 103.

In this embodiment example, the sliding element 1 has a channel-shaped groove 60 which is intended to hold the spring 2 (FIG. 14b). In order to obtain as large as possible a bearing surface or bearing line, the radius of this channel-shaped groove 60 roughly corresponds to the radius of the cross-section of the spring 2. For this, the spring 2 is preferably formed with a circular cross-section at least in its end areas.

In the exploded representation of FIG. 14a, it can furthermore be clearly seen that the sliding elements 1 and 11 are formed as separate assemblies. It is thereby made possible to also subsequently attach such a sliding element 1 and 11—to already existing furniture hinges, which results in the advantage that it is not absolutely necessary to replace the entire furniture hinge in case of need, but it is sufficient to retrofit existing furniture hinges with this sliding element 1 and 11. Naturally, it is likewise envisaged to produce new furniture hinges which have such sliding elements 1 and 11.

FIG. 15 shows a piece of furniture 200 with a movable furniture part 112 and a first furniture part 111 which is formed as a cabinet body.

The cabinet body 111 is connected to the movable furniture part 112 via two furniture hinges 100.

The furniture hinges 100 are attached to the first furniture part 111 with their fittings 101 and attached to the second, movable furniture part 112 with their hinge cups 102. The furniture part 112 is thereby movably mounted on the cabinet body 111.

Although the invention has been described specifically using the embodiment examples shown, it goes without saying that the subject-matter of the application is not limited to these embodiment examples. Rather, it goes without saying that measures and modifications that serve to implement the inventive idea are perfectly conceivable and desired. Thus, as already mentioned in the description of the figures, a sliding element could be used in hinges other than those shown—such as for instance in four-point hinges. It would likewise be conceivable that the control cams are formed, not on the articulated lever, but on the sliding element itself or also on the sliding element and on the articulated lever. Naturally, it would likewise also be conceivable that the control cam is formed on the spring.

1. A device comprising a furniture hinge with at least one control cam and at least one spring, wherein the control cam moves along on the spring in order to produce a closing force and/or opening force, wherein a sliding element, on which the control cam or the spring moves along, is attached to the spring and/or to the control cam.

2. The device according to claim 1, wherein the furniture hinge has a fitting for attachment to a first furniture part and a hinge cup for attachment to a second furniture part, wherein the hinge cup is swivellably connected to the fitting via at least one articulated lever, wherein the control cam is formed on the articulated lever.

3. The device according to claim 1, wherein the sliding element is pushed onto the spring and/or attached to the control cam.

4. The device according to claim 1, wherein the sliding element is at least partially formed from plastic and/or in that the spring is formed from metal.

5. The device according to claim 4, wherein the plastic of the sliding element is formed as a thermoplastic.

6. The device according to claim 5, wherein the thermoplastic is polyoxymethylene (POM).

7. The device according to claim 4, wherein the metal of the spring is steel.

8. The device according to claim 1, wherein the sliding element is attached to one end of the spring.

9. The device according to claim 1, wherein the sliding element has at least one reservoir for a lubricant.

10. The device according to claim 1, wherein the sliding element has an outer contour differing from the cylinder shape.

11. The device according to claim 1, wherein the sliding element has a substantially cylindrical cavity.

12. The device according to claim 1, wherein the sliding element has at least one control cam or at least one projection.

13. The device according to claim 1, wherein the sliding element has a curved plane, wherein the curved plane is formed substantially straight in a transverse extension and is formed curved in a longitudinal extension.

14. The device according to claim 1, wherein the sliding element has a channel-shaped groove.

15. The device according to claim 1, wherein the sliding element is formed as a separate assembly.

16. The device according to claim 1, wherein the sliding element is formed in one piece.

17. The device according to claim 1, wherein the furniture hinge has at least two sliding elements.

18. The device according to claim 1, wherein the spring has a substantially cylindrical cross-section at least at one end.

19. The device according to claim 1, wherein the spring has a circular cross-section at least in some areas.

20. The device according to claim 1, wherein the spring is formed as a leg spring.

21. The device according to claim 4, wherein the sliding element is substantially completely formed from plastic.

22. A piece of furniture with at least one movable furniture part, wherein the furniture part is movably mounted via at least one furniture hinge according to claim 1.
